(19) United States
(12) Patent Application Publication
(10) Pub. No.: US 2018/0078861 A1
(43) Pub. Date: Mar. 22, 2018

(54) METHOD AND APPARATUS FOR PROVIDING A COMPUTER IMPLEMENTED GAME

(71) Applicant: KING.COM LIMITED, St. Julians (MT)

(72) Inventor: Markus Borggren, Malmo (SE)

(21) Appl. No.: 15/366,642

(22) Filed: Dec. 1, 2016

Related U.S. Application Data
(60) Provisional application No. 62/396,392, filed on Sep. 19, 2016.

(51) Int. Cl. A63F 13/80; A63F 13/798; A63F 13/87; A63F 13/35; A63F 13/33

(52) U.S. Cl. CPC A63F 13/80; A63F 13/798; A63F 13/33; A63F 13/35; A63F 13/87

(57) ABSTRACT

A game server initiates a competition between two players. Each of the players is playing a single player computer implemented game. The competition lasts for a first period of the time. A game state is determined for each of the players at the start of the competition. Game performance information is provided from the device of each player during the first period of time. The game states and the game performance information is used to determine a relative game metric which is transmitted to the devices.

### CROSS-REFERENCE TO RELATED APPLICATIONS

This application is based on, and claims priority to U.S. application Ser. No. 62/396,392, filed Sep. 19, 2016, the entire contents of which being fully incorporated herein by reference.

### FIELD OF THE INVENTION

Embodiments of this application relate to a user device and a server for use in playing a computer implemented game.

Some embodiments may relate to engaging users or players in a computer game executable in an online environment.

### BACKGROUND OF THE INVENTION

There exist many types of computer device where the display is controlled by an input. In some embodiments the input may be a cursor or pointer that is controlled by a human interface device such as a mouse, joystick, keyboard etc. Additionally or alternatively the display may comprise a touchscreen which can be controlled by a user's touch. That is, activation of functions and objects is responsive to user input made by way of the user actually touching a particular object displayed on the screen, and thereby selecting that object.

So-called “saga-games” are known where there are many different levels which a user can play. One technical challenge with such games is how to provide technical complexity of a game whilst at the same time providing a varied gaming experience for the user. Another significant technical challenge is how to retain casual game play where a user is able to play a game as and when they like while at the same time having an aspect which involves interaction with other players.

This patent specification describes not only various ideas and functions, but also their creative expression. A portion of the disclosure of this patent document therefore contains material to which a claim for copyright is made and notice is hereby given: Copyright King.com Limited 2016 (pursuant to 17 U.S.C. 401). A claim to copyright protection is made to all screen shots, icons, look and feel and all other protectable expression associated with the games illustrated and described in this patent specification.

The copyright owner has no objection to the facsimile reproduction by anyone of the patent document or the patent disclosure, as it appears in the Patent and Trademark Office patent file or records, but reserves all other copyright rights whatsoever. No express or implied license under any copyright whatsoever is therefore granted.

### SUMMARY OF THE INVENTION

Some embodiments may provide a computer implemented method comprising: selecting by at least one processor a selection of a first player of a computer implemented single player game to have a competition with a second player of a computer implemented single player game, said competition lasting a first period of time; receiving by a receiver game performance information from a first computer device associated with the first player and game performance information from a second computer device associated with the second player, said game performance information being associated with game play of said respective single player computer implemented game within said first period of time; using by said at least one processor said game performance information associated with the first player, said game performance information associated with the second player and respective game states associated with the first and second players to determine at least one relative game metric for at least a part of said first period of time; and transmitting by a transmitter said at least one relative game metric to at least one of the first computer device associated with the first player and the second computer device associated with the second player.

The computer implemented game may comprise a casual social game

The computer implemented game may comprise a plurality of different levels, said game performance information comprising one of n performance values for a respective level.

When the game performance information is for a level which has previously been played, said at least one relative metric may be dependent only on one or more additional game performance values newly achieved as compared to a respective game performance value previously achieved.

The method may comprise using a respective one of said game state and said game performance information to determine said additional game performance values.

The method may comprise starting a timer to start said first period of time.

The selecting may comprise selecting said first player in dependence on activity information associated with said first player and activity information associated with said second player.

The selecting may comprise selecting said first player from a set of possible first players, said possible first players being identified as social media contacts of said second player.

The selecting may comprise receiving from said computer device associated with said second player information identifying said first player.

The method may comprise performing a plurality of times during said first time period said steps of using of said game performance information to determine said relative game metric for said first and second players and transmitting said relative game metric to at least one of the computer device associated with the first player and the computer device associated with the second player.

The using and transmitting steps may be performed in response to playing of a level of the computer implemented game by at least one of the first and second players on the respective computer device.

The method may comprise determining that there is at least a defined difference in game performance associated with the first and second players and in response thereto, adjusting the game performance information associated with least one of said first and second players to facilitate a reduction in a difference in said game performance, said relative game metric being dependent on the difference in said game performance. The method may comprise transmitting a notification to at least one of said first computer device associated with said first user and said second computer device associated with said second user, said notification comprising information indicating selection of the respective user for said competition.

The notification may be an in game notification.

The transmitting may comprise providing a push message, said push message comprising said information about said at least one relative game metric.

The push message may be provided in response to a change in lead in said competition.

The push message may be sent to the player no longer in the lead and/or the player newly in the lead.

The method may comprise using at least one of said first and second computer devices to provide a visualization of said relative performance metric in said respective game.

The method may comprise receiving an updated relative performance metric and using said updated relative performance metric to update said visualization.

The method may comprise storing said respective game states and updating said game state in response to response to receiving said game performance information.

The method may comprise determining if said received game performance indicates an improvement over a previous game performance and updating said game state only if there is an improvement over said previous performance.

The method may comprise determining at an end of said first time period a game state associated with said first player and a game state associated with said second player, comparing said determined respective game states at the end of the first time period with the corresponding respective game states at the beginning of the first time period to determine a relative performance of said first and second players.

The method may comprise providing an in-game reward to the player having a better performance.

According to another aspect, there is provided a game server comprising: at least one processor configured to select of a first player of a single player computer implemented game to have a competition with a second player of the same single player computer implemented game, said competition lasting a first period of time; at least one memory configured to store respective game states associated with the first and second players; a receiver configured to receive game performance information from a computer device associated with the first player and game performance information from a computer device associated with the second player, said game performance information being associated with game play of said single player computer implemented game within said first period of time, said at least one processor configured to use said game performance information associated with the first player, said game performance information associated with the second player and said respective game states to determine at least one relative game metric for at least a part of said first period of time; and a transmitter configured to transmit said at least one relative game metric to at least one of the computer device associated with the first player and the computer device associated with the second player.

The computer implemented game may comprise a casual social game

The computer implemented game may comprise a plurality of different levels, said game performance information comprising one of n performance values for a respective level.

When the game performance information is for a level which has previously been played, said at least one relative metric may be dependent only on one or more additional performance values achieved as compared to a respective performance value previously achieved.

The at least one processor may be configured to use a respective one of said game state and said game performance information to determine said additional performance values.

The game server may comprise a timer. The timer may be a hardware and/or a software timer.

The at least one processor may be configured to select said first player in dependence on activity information associated with said first player and activity information associated with said second player.

The at least one processor may be configured to select said first player from a set of possible first players, said possible first players being identified as social media contacts of said second player.

The receiver may be configured to receive information from said computer device associated with said second player information identifying said first player.

The at least one processor may be configured, a plurality of times during said first time period, to use said game performance information to determine said relative game metric for said first and second players and said transmitter may be configured to transmit said relative game metric to at least one of the computer device associated with the first player and the computer device associated with the second player a plurality of times during said first time period.

In response to playing of a level of the computer implemented game by at least one of the first and second players on the respective computer device, the at least one processor may be configured to use said game performance information to determine said game metric.

The at least on processor may be configured to determine that there is at least a defined difference in game performance associated with the first and second players and in response thereto, adjusting the game performance information associated with least one of said first and second players to facilitate a reduction in a difference in said game performance, said relative game metric being dependent on the difference in said game performance.

According to other embodiments, there is provided a non-transitory computer readable medium encoded with computer executable instructions for controlling a game server which when executed by at least one processor cause the said at least one processor to perform the following steps: select a first player of a single player computer implemented game to have a competition with a second player of the same single player computer implemented game, said competition lasting a first period of time; receive game performance information from a computer device associated with the first player and game performance information from a computer device associated with the second player, said game performance information being associated with game play of said single player computer implemented game within said first period of time; use said game performance information associated with the first player and said game performance information associated with the second player and said respective game states associated with the first and second players to determine at least one relative game metric for at least a part of said first period of time; and cause transmission of said at least one relative game metric to at least one of the computer device associated with the first player and the computer device associated with the second player.

A computer program comprising program code means adapted to perform the method(s) may also be provided. The computer program may be stored and/or otherwise embodied by means of a carrier medium.

In the above, many different embodiments have been described. It should be appreciated that further embodiments may be provided by the combination of any two or more of the embodiments described above.

Various other aspects and further embodiments are also described in the following detailed description and in the attached claims.

### BRIEF DESCRIPTION OF DRAWINGS

To understand some embodiments, reference will now be made by way of example only to the accompanying drawings, in which:

FIG. 1a shows a first example embodiment of a game board;

FIG. 1b shows a second example embodiment of a game board;

FIG. 2 shows an example user device in which some embodiments may be provided;

FIG. 3 shows an example system in which some embodiments may be provided;

FIG. 4 shows a method of an embodiment;

FIG. 5 schematically shows a representation of different levels of a game;

FIG. 6 schematically shows a zoomed representation of some of the different levels of the game;

FIG. 7 shows a data structure used in some embodiments;

FIGS. 8a to 8c show example information displayed on a display of a user device for a first example game and FIGS. 8d to 8f show example information displayed on a display of a user device for a second example game;

FIG. 9 shows an example of score information displayed on a display;

FIGS. 10a to 10d show a first example of a score information format;

FIG. 11a to 11d show a second example of a score information format;

FIG. 12 shows an example of a server used in some embodiments;

FIGS. 13a to 13c shows example score information displayed on a display;

FIGS. 14a to 14c show example information displayed on a display of a user device during a game and at an end of a game.

### DETAILED DESCRIPTION OF SOME EMBODIMENTS

One example of a game with which embodiments may be used is a ‘match-3 game’ where the player is required to find patterns on a seemingly chaotic board. The player then has to match three or more of the same type of game element on the game board and those matched elements will then disappear. In some games the user has to match more than 3 game elements.

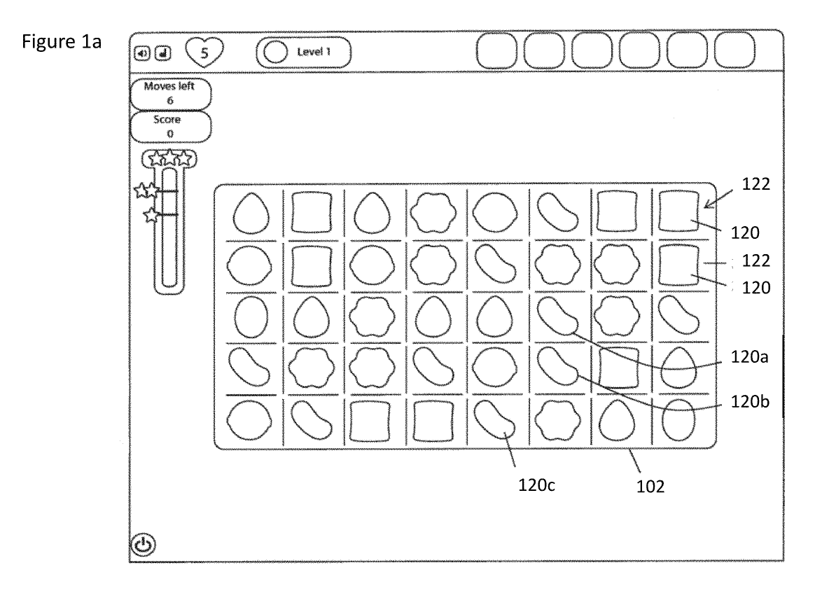

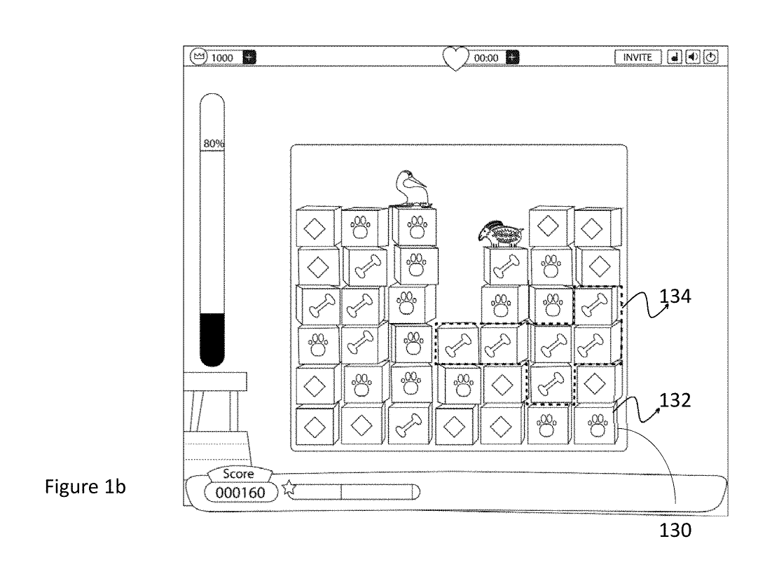

FIG. 1a shows a display of a known version of a match 3 switcher game called Candy Crush Saga™. FIG. 1a illustrates a game board 102 with a plurality of game elements 120. The game elements are each of six different shapes and colours. Each game element is supported by a tile 122. The tiles are not readily visible to a player of the game—the game elements are the main focus for a player. However, the tiles govern characteristics of the game elements which are visible to a player as will be described in more detail later.

In the known version of the match 3 switcher game, the aim of the game is to swop game elements in the shape of candies with each other to make moves on the game board. To gain points the player has to make moves that create matches of at least three of the same candy. In doing so, the player gains points and the matched candies are removed. As a result new candies fall into place from the top of the game board in order to fill any spaces created. Assume in FIG. 1 that game element 120c is moved one place to the right to form a three-line match with game elements 120a and 120b. This has the effect of game board elements 120a, 120b and 120c “disappearing”, creating a visual effect (animation) on the screen to indicate the disappearance. The two game elements which were directly above game elements 120a will now fall downwards into the spaces created by the removal of game elements 120a, 120b and 120c. The game elements on the newly created tiles which fall downwards into the game board are generated at random. The user then has a new game board on which to play a subsequent move.

Another example are the so called ‘clicker’ games where the player can click on a group of adjacent game elements of a certain type and those will then be removed. Some clicker games only require two adjacent objects to remove those elements if clicked by the user. Others may require more than two.

FIG. 1b shows a display of a known version of a clicker game called Pet Rescue™. FIG. 1b illustrates a game board 130 with a plurality of game elements or blocksl 32.

To play the game, the user will, via a user interface, click on any group of two or more touching blocks of the same colour. In the example shown in FIG. 1b, the user has clicked on the group referenced 134 and surrounded by dotted lines. Clicking on this group will cause these blocks to be removed from the game board. In some embodiments, new blocks will not appear on the game board. The remaining game element blocks drop down and slide left to fill gaps on the game board. There may be elements blocking the game elements to fall down or slide left and the game designer may implement certain rules for certain game elements.

Another type of match games are the so called ‘switcher’ games where the player switches place on two adjacent game elements on the game board so that one or both of them create a chain of at least three adjacent game elements of the same type. Those matched game elements will then disappear. In a typical switcher game the game board will be repopulated with game objects.

Another type of match game are the so called ‘shooter’ games where the player launches for example a ball or bubble on to the game board trying to aim at groups of similar game elements already on the game board. If the launched ball hits or forms a group of more than 3 similar game elements then that group of game elements are removed from the game board.

It is clear that embodiments may be used with any other suitable type of games.

In some embodiments, the game may be provided with different levels. Each level may have a specific goal.

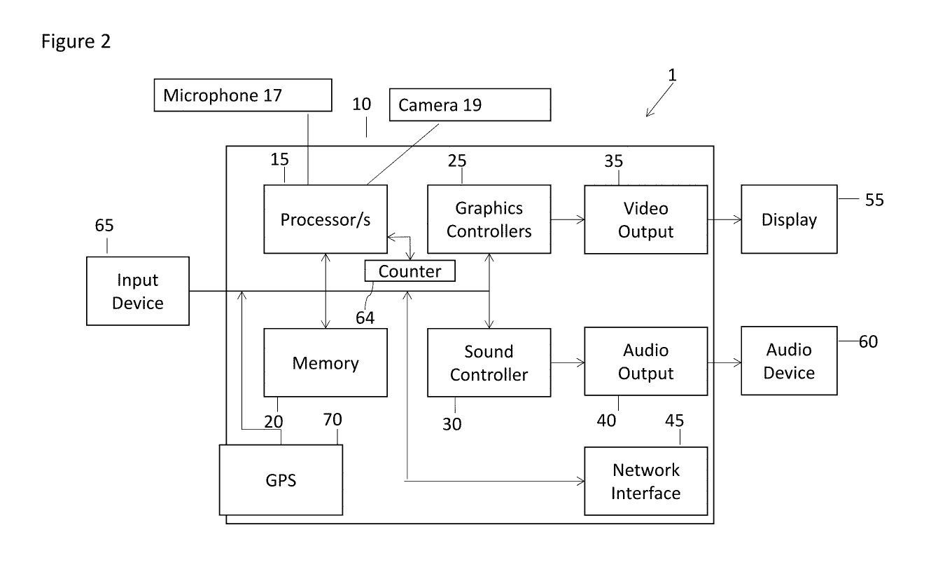

A schematic view of a user device 1 according to an embodiment is shown in FIG. 2. All of the blocks shown are implemented by suitable circuitry. The blocks may be implemented in hardware and/or software. The user device may have a control part 10. The control part may be implemented by one or more processors 15 and one or more memories 20.

The control part 10 is shown as having a graphics controller 25 and a sound controller 30. It should be appreciated that one or other or both of the graphics controller 25 and sound controller 30 may be provided by the one or more processors 15 or may be separately provided. The graphics and sound controllers may comprise memory and/or may operate in conjunction with the one or more memories 20.

The graphics controller 25 is configured to provide a video output 35. The sound controller 30 is configured to provide an audio output 40. The video output 35 is provided to a display 55. The audio out 40 is provided to an audio device 60 such as a speaker and or earphone(s).

An audio capture device such as a microphone 17 may be provided. An audio input may be captured by the microphone and may be processed by the processor and/or any other suitable processor. This is optional is some embodiments

In other embodiments, the sound controller and audio device may additionally capture and process audio data.

An image capture device 19 may be provided. The image capture device is a camera in some embodiments. The image captured by the camera may be processed by the processor and/or any other suitable processor. This is optional is some embodiments

The control part 10 has an interface 45 allowing the device to be able to communicate with a network such as the Internet or other communication infrastructure. The control part 10 may have a GPS module 70 or similar configured to provide location information to the at least one processor 15 or memory 20. This is optional is some embodiments.

The device 1 has an input device or user interface 65. The input device can take any suitable format and can be one or more of a keyboard, mouse, touch screen, joystick or game controller. It should be appreciated that the display 55 may in some embodiments also provide the input device 65 by way of an integrated touch screen for example.

The device has a counter 64 or a count function. The counter may be a hardware counter or a software counter. The counter is configured to communicate with one or more of the processors. Information from the counter may be stored in a counter memory and/or the memory 20. This is used to count number of attempts associated with a level. A separate counter may be provided for each game level or for each game level which has not been completed. Alternatively or additionally, the count value for a particular game level may be loaded into the counter from memory, when a different game level is selected by the user. It should be appreciated that a count function may be provided by storing a value in memory and that value may be updated by, for example, a processor.

The blocks of the control part 10 are configured to communicate with each other by an interconnect such as a bus or any other suitable interconnect and/or by point to point communication.

It should be appreciated that in some embodiments, the controller may be implemented by one or more integrated circuits, at least in part.

The user device 1 is shown by way of example only. In alternative embodiments, one or more of the parts may be omitted. Alternatively or additionally, some embodiments may comprise one or more other parts. Alternatively or additionally, one or more parts may be combined.

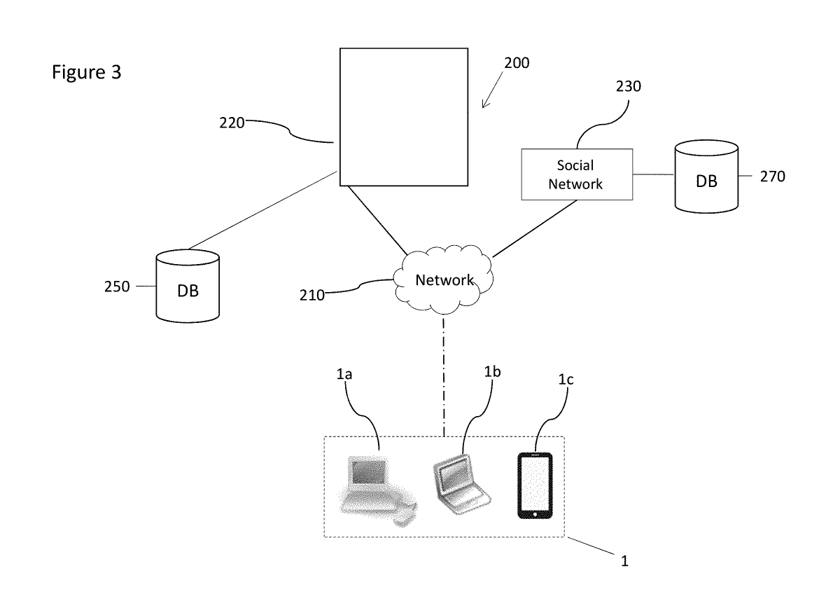

FIG. 3 schematically shows a system 200 according to an embodiment. The system 200 comprises a server 220 which may store or be in communication with database 250 which may, in some embodiments, store game player's details, profiles, statistics etc. In practice, one or more databases 250 may be provided. In practice, one or more servers 220 may be provided. Where one or more server is provided, the database(s) 250 may be provided in one database 250 across two or more servers.

The server 220 may communicate via, for instance, the internet 210 to one or more client or user devices 1, shown in FIG. 3 by way of example as user devices 1a, 1b and 1c, and may further provide connections to a social network 230, for example, Facebook™. The social network 230 may also be connected to a database 270 storing social user interaction details, for instance, user to user interaction maps, friend lists, location history etc. In practice, one or more databases 270 may be provided. The connection to the database 270 of the social network 230 may result in a local copy of the database 270 being made on the user device 1.

It should be recognised by those skilled in the art that the databases herein referred to may comprise external or remote storage, such as that described as being in a “cloud”.

It should be appreciated that embodiments may be deployed in different system architectures. For example, the computer game may be implemented as a computer game that is stored in the memory of the user device and is run on the processor of the user device. However, the server may handle some elements of the game in some embodiments. By way of example only, a Java game applet may be provided to the user device and the locally running Java applet will generate, for example, the graphics, sounds, and user interaction for the game play on the user device. Some data may be fed back to the server to allow interaction with other user devices 305. The data which is fed back may also allow scoring and/or cross platform synchronization.

In some embodiments, the game may be implemented as a computer program that is stored in a memory of the system, for example the server, and which runs on a processor of the game server. Data streams or updates are supplied to the user device to allow the user device to render and display graphics and sounds in a browser of the user device. Such an approach is sometimes referred to as a web services approach. It should be appreciated, however, that such an approach does not necessarily require the use of the Internet.

The game may be played in an offline mode on a handheld device using locally stored information on the handheld device. The device may store all or some of the levels that are available as applicable to the particular game and its saga or mission objectives. Some of the features may be locally executed on the device. This may for instance implement a scheme to regenerate lives after a certain period of time, the time may be locally decided based on the clock on the device. In some embodiments, the central game server clock may override the local clock when the local device has been synchronised with the server.

Some embodiments may be implemented to synchronize game state information and/or retrieve and connect to social graph information and user profile data on a social network such as Facebook or Google+™.

Some embodiments may be implemented to enable connection to a plurality of social networks. The user may be given the option to select which information may be derived and/or shared with which social network.

Some embodiments may be provided in the context of so-called saga games. These are games which have one or more levels. In some games, a user may be required to complete a certain level before the user is able to progress to a next level. In some embodiments, the user may be able to go back and play any previous level.

A game may have a number of different levels. Different levels may have different requirements to be met. For example, some levels may have one or more specific goals. These goals could be to reach a certain amount of points before running out of moves or time; to bring down certain game elements to the bottom of the screen; to remove a certain amount of game elements before running out of moves or to collect certain game elements through specific matches before running out of moves. These are by of example only, and any other additional or alternative goals may be provided.

If the game becomes difficult there are boosters to help the player pass a level. These can be obtained from in-game purchases or received as gifts from Facebook friends.

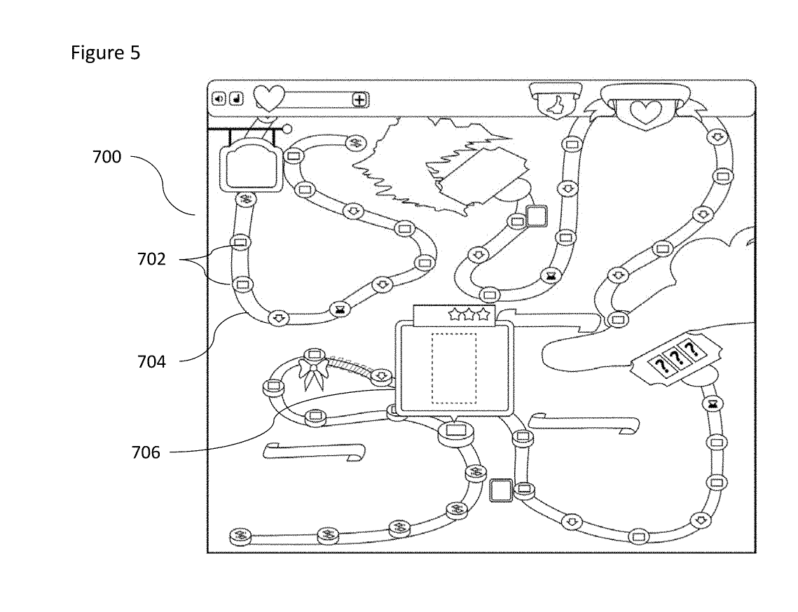

In some embodiments, the different levels may be represented on a map 700. FIG. 5 schematically shows one example of such a view. Different levels 702 are represented on a path 704 so that the user can see the progress which he has made playing the game. This also allows a user to go back and replay levels which he has previously played. The map view may show what levels have been completed as well as how many levels are left to play. Throughout the game and for each level completed, the player journeys across the map. In some embodiments, the levels are divided up into groups or chapters. These may be referred to as episodes. In some embodiments, there may be a theme associated with each chapter.

In some embodiments, if the player has connected to a social network, then friends' progress from the same network may be viewed on the map by the means of information provided next to the highest level they have currently reached or by virtual of a league table which can be displayed.

In the map view, the player can hover over a level to display a thumbnail 706 of it. This makes it easier to find specific already completed levels, and can also give the player an idea of what to expect before actually starting a level. In some embodiments, thumbnails can be displayed for any level. In some embodiments, no thumbnails can be displayed for levels that have not yet been reached. In some embodiments, the thumbnail option is not provided.

Information may be provided on the map to display how well the player has done on the level if he has played it previously. This can for instance be represented with the number of stars the player has received on that level, the actual score or some other indication. This may be done via the thumbnail option, by displaying information on the map or by any other suitable mechanism.

When navigating on a map in a game, it may sometimes be difficult to find desired level or area of the map if the map is, for example, too large relative to the available display. In some embodiments, a smaller version 720 of the map is displayed. The user is able to select a part of that map to be displayed on the display such that the part of the map displayed is larger than when the entire map is displayed. The smaller version of the map will highlight the part of the map which is being displayed in enlarged from.

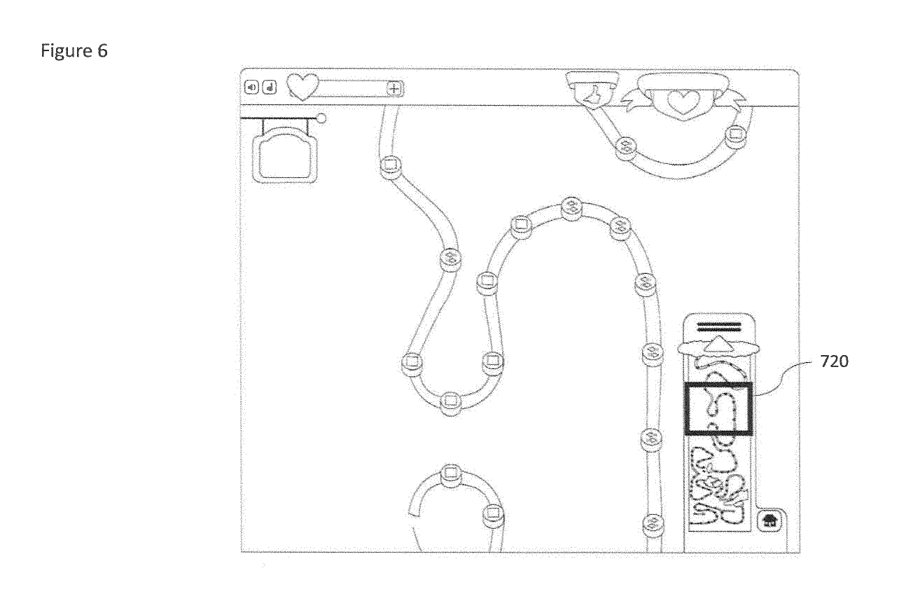

In some embodiments, the smaller version of the map is only in full view when the player needs it; the rest of the time the smaller version of the map may be hidden with only a small part of it showing. Clicking on this small part will expand the smaller version of the map such as shown in FIG. 6 and referenced 720 and let the player use it. Clicking on the same part again will once more hide the smaller version of the map. When the smaller version of the map is expanded, the player is provided with a mini map showing an area of the map. The player can select anywhere on the mini map and when doing so the main view will jump to the same location, but zoomed in. The player may also scroll through the mini map which will then simultaneously scroll the map in the main view.

In some embodiments, the game can be implemented so that a player progresses through multiple levels of changing and typically increasing difficulty. As the player travels through the levels in the game, his progress may be represented as a journey along a path in the virtual map.

In some embodiments, the player moves between levels and completes the levels one by one along a path by playing the associated game. When the player reaches the goal of a level, the next level is unlocked and the player can play that level in the game.

The number of stages and levels can vary depending on the implementation. The levels may be numbered consecutively throughout the game or they can be numbered within a stage, it is also understood that other ways of identifying the levels can be provided.

One way of unlocking new stages is to complete the last level on the latest stage. The user may in some embodiments be provided with challenges to unlock the next stage in the virtual map.

In some embodiments, the user can play any of the unlocked levels on the map, so the user can go back and replay already completed levels to get a better score or beat friends' high scores.

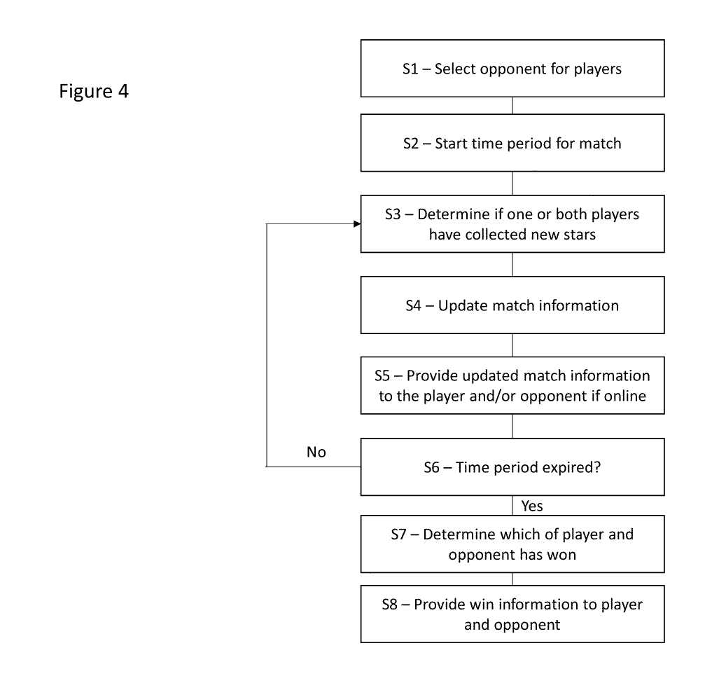

Reference is made to FIG. 4 which shows a method of an embodiment.

In step S1, an opponent is selected for a current player. In some embodiments, an opponent is selected by, for example, a game server.

The selection may be made from amongst other players with which the current player has a connection. For example, the opponent may be selected from social media friends of the current player which also play the game in question. Alternatively or additionally, the opponent may be selected from any other suitable pool of players.

In some embodiments, a plurality of groups may be provided. There may a hierarchy for selection from these groups. For example a check is made to see if a player with a similar activity is in a first group and if not the next group is checked. In some embodiments, one group may comprise social network friends, for example Facebook friends. Another group may comprise players where the connection is to the player via the game environment.

In some embodiments, the opponent may is selected such that the opponent has a connection with the first player.

In some embodiments, opponents may be selected using any other suitable criteria and are not social media friends of the current player.

In some embodiments, an opponent will be selected or be eligible for selection only if that player is not currently playing with somebody else.

In some embodiments, activity level is taken into account. Accordingly, in some embodiments, if the current player is very active, for example plays the game every day, then the opponent selected will have a similar activity level.

In some embodiments, an opponent that has a similar progress level may be selected. However, in other embodiments, the progress level may not be taken into account.

In some embodiments, there may be a threshold whereby only players which have reached at least a certain level of the game can be selected as an opponent and/or as the current player in a match.

In some embodiments, an opponent may be selected if their progress is within x levels of the current player, where x is any suitable integer.

In some embodiments, the selection criteria is used to define a set of potential opponents. The set of potential opponents may be changed over time.

The opponent may be selected from the set of potential opponents using a randomisation mechanism in order to allow the current player to be matched with different opponents over time.

In some embodiments, an indication will be stored in game data as to whether or not a particular player has been an opponent of the current player and if so, that opponent will not be selected or a minimum amount of time between selections may be required.

In some embodiments, once the opponent has been selected, the opponent is removed from the pool of potential opponents.

In some embodiments, if there has been a match or competition between two players, one or other of the players is able to request a rematch.

Alternatively or additionally if the match or competition has been close (i.e. the difference in performance has been small) the server may be configured to select a rematch).

Alternatively or additionally if there has been an increase in activity level of the current player and/or the opponent, the server may be configured to select a rematch.

In some embodiments, one or more conditions for a rematch may be defined and in response to these conditions, the server may be configured to select a rematch.

In some embodiments, the server may be configured to send a message to one or both players indicating that there is a possibility of a rematch and if one or both of the players agrees to the rematch, then there is a rematch. The server may be configured to send the message if one or more conditions for a rematch are satisfied. The agreement may be provided by the user interacting with the user device via the user interface which causes a message to be transmitted to the server with the agreement (or not). In the absence of agreement, a different opponent will be selected.

In some embodiments, a pool of potential opponents is provided for each player. In some embodiments, a common pool of potential opponents is used by two or more current players.

In some embodiments, the opponent may be selected from players which are currently served by the same server or server shard as the current player. This may minimise the number of reads to the database/cache and hence reduce latency.

In alternative embodiments, the currently player may be able to select their desired opponent.

In some embodiments, one or more criteria may be used when determining potential opponents and/or the selection thereof.

In some embodiments, when the match or competition starts may be in response to one or more game events.

In some embodiments, when the match or competition starts may be controlled by the server.

In step S2, a time period is started for the match. This time period may be controlled by a timer. The timer may be a hardware or software timer. This information may be communicated to the computer device of the current player and/or the computer device of the opponent, depending on whether the respective players are online. This timer may be used to control when the time period is ended,

In step S3, information about the game state for each of the players at the beginning of the time period is determined or stored in some embodiments. In other embodiments, the game state information for each of the player is considered to be zero. The approach taken will depend on how game performance is measured in the game and/or the criteria to be applied in the match or competition.

In some embodiments, this information may be updated during the time period as one and/or other of the players play the game.

As one and/or other players play the game on their devices, game performance information is provided. When a game is played on a device, information about that game is provided to the game server.

The game performance information may be compared to the current game state information to determine a relative game metric.

By way of example, where a player completes a level, they will obtain one or more stars. This may be game performance information.

In some embodiments, it is determined whether the current player and/or the opponent have collected any new stars through playing the computer implemented game. That may be determined using the current game state information. As mentioned previously, when a player completes a level, depending on how well the player performed in that game, they will be given one or more stars.

If a new level is completed, then the stars associated with that level are used in determining the relative game performances of the currently player and the opponent.

It should be appreciated that in some embodiments, if a player re-plays a level to attempt to get more stars, only the additional stars will be provided in the game state information used in determining the relative game performances. For example, if a player initially plays a level and gets one star and subsequently plays that level and gets 3 stars, only 2 stars will be used in determining the relative performances. In other embodiments, all the stars of a replayed level may be used in determining the relative performances.

In some embodiments, the information reflecting only the number of new stars, for example, may be determined in the player's device or in the game server.

It should be appreciated that the game state information may be updated if for example there are new stars. This may be during the competition. In the embodiments using the star mechanism, the game state information may comprise information on the levels which have been completed by a player and the number of stars.

It should be appreciated that the star mechanism is by way of example and any other suitable measure of game performance may be alternatively be used.

In step S4, the relative game performance metric or information is updated. This is to reflect the performance of the current player and the opponent with respect to one another. This may be reflected in total number of stars which each player has achieved. This may be used to determine which player is leading in the match.

In step S5, up-to-date relative game performance information may be provided to one or both of the current player and the opponent depending on their online status. In some embodiments, the relative performance information may be updated each time one of the opponent and the player successfully completes a level. In other embodiments, the updating of the relative performance information may take place at predetermined times. In other embodiments, the updating may only take place at the end of the match. In some embodiments, the update may only be provided if there is a change in lead or if the players are level.

In step S6, it is determined if the time period has expired. If not, the method reverts to step S3.

If the time period has expired, the next step is S7. It is then determined which player has won. This may be done by comparing performance information of each of the players.

In other embodiments, a value is updated in response to game performance information (for example numbers of new stars). At the end of the time period, the value is compared to a threshold to determine the winner.

For example, an initial game value may be initialised when the first time period is started. For one player, their game performance information will cause the value to be incremented and for the other player, their game performance information will cause the game value to be decremented. At the end of the time period, if the final game value is above the initial value then the one player is determined to have won the match or competition. If the final game state value is below the initial value then the other player is determined to have won the match or competition.

In step S8, information is provided to the current player and opponent indicating which of players has won and/or which of the players has lost.

In some embodiments, when an opponent is selected for current player, that opponent will receive a message indicating that they have been selected for the match.

In some embodiments, push notifications are sent. These notifications may be sent for example whenever the player which in is in the lead changes and/or whenever the score changes and/or at the end of the match.

In some embodiments, a reward may be associated with winning. The reward may comprise any suitable in game reward.

It should be appreciated that the time period for the match or competition may be controlled by the server. The time period may have a fixed length of time. In some embodiments, the fixed length of time of the match or competition may be dependent on the activity levels of one or more of the other players. In some embodiments, the time period may be depend on the number of matches played by one or both of the players. In other embodiments, the time period may be variable and for example may be defined by the first player which achieves a given target or the like.

In the described embodiment, the match or competition is described as being between 2 players. It should be appreciated that in other embodiments, the match or competition may be between a group of 3 or more players.

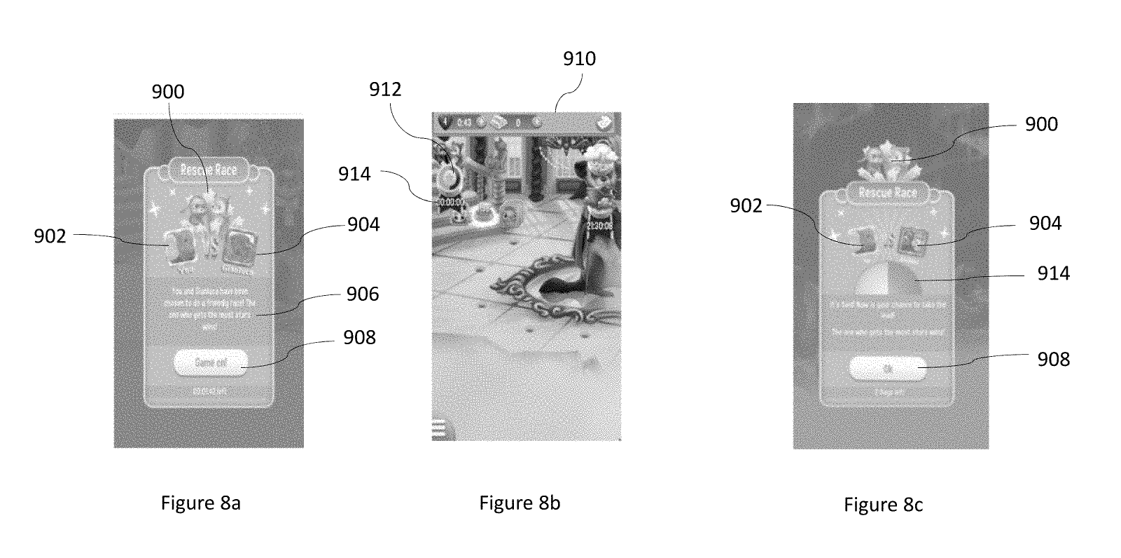

FIGS. 8a-c show an example of information which is provided to a player relating to the match for a first example game.

Reference is first made to FIG. 8a. The information displayed on the display may include information 900 indicating a match. This information can take any suitable form and may for example be an icon, message or the like. Information 902 and 904 may also be displayed on which player are taking part in the match. In some embodiments, information 902 about the current player is displayed along with information 904 about the opponent. In some embodiments, this information may take the form of an avatar and/or name information. In some embodiments, information about the current player may be omitted. The information may comprise a message area 906 which in FIG. 8a has information indicating to the player of the device that the match or competition has started. The displayed image may have an interaction area 908 which when selected via input to the user interface causes the user to progress to the next stage. In FIG. 8a, this would take the user to a game playing mode.

Reference is made to FIG. 8b which shows an image of a game screen presented to the user. This may for example be after interaction with the interaction area 908 of the image shown in FIG. 8a. The image may include score information 912 and information 914 indicating a lapsed and/or remaining time for the match. Some examples of how the score information may be presented will be described in more detail later.

In some embodiments, the player may be presented with score information at the completion of each level or at the end of the level regardless of whether it is successful or not. As can be seen from FIG. 8c, this information may comprise information 900 indicating that a match or competition is ongoing, information 902 about the current player and information 904 about the opponent. The image displayed will also show a score part 914 which will show the current score in the match. Again an interaction area 908 is provided whereby interaction with that area will cause the next screen to be displayed.

FIGS. 8d to 8f show an example of information which is provided to a player relating to the match for a second example game.

Reference is first made to FIG. 8d. The information displayed on the display may include information 800 about a possible match. For example, this information may explain the goal to be achieved in order to win the game. In some embodiments, there is an icon 802 displayed which when selected causes an opponent for the player to be found. In some embodiments, selection of the icon 802 is required in order for an opponent to be found for the player. In other embodiments, selection of the icon or other interaction by the user with the device is not required for the opponent to be found. In this latter case, the server may control which players are selected for a match and when.

FIG. 8e shows an example image which is displayed where the user has selected the icon to cause an opponent to be found. In this example, the image has a message 804 to the user indicating that an opponent is being searched for. In some embodiments, where the player is automatically selected for a match by the server, without the input of the player, this example image may still be displayed. In the example image shown in FIG. 8e, there is an icon 806 which when selected will take the user away from the screen displayed in FIG. 8e and may for example allow the player to continue to play the game. The image shown in FIG. 8e may show an image or avatar 808 representing the player (if available) and have an image 810 representing the image of a mystery opponent.

When a suitable opponent has been found by the server, the example image shown in FIG. 8f may be displayed. This will have the image or avatar 808 of the player and the image or avatar 810 of the opponent, assuming these images and/or avatars are available. The example the image may have information 814 indicating that the match has started. There may be an icon 812 which when selected by the player allows the player to start playing the match.

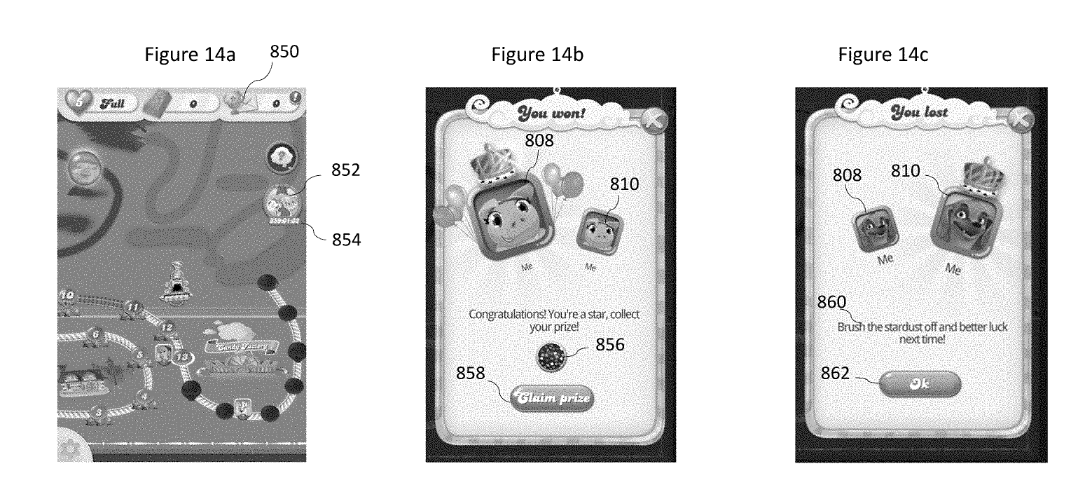

Reference is made to FIG. 14a which shows an image 850 of a game screen presented to the user, for example for the game shown in FIGS. 8d to 8f. This shows a so-called saga map. The image may include information 852 indicating that a match is taking place and information 854 indicating a lapsed and/or remaining time for the match.

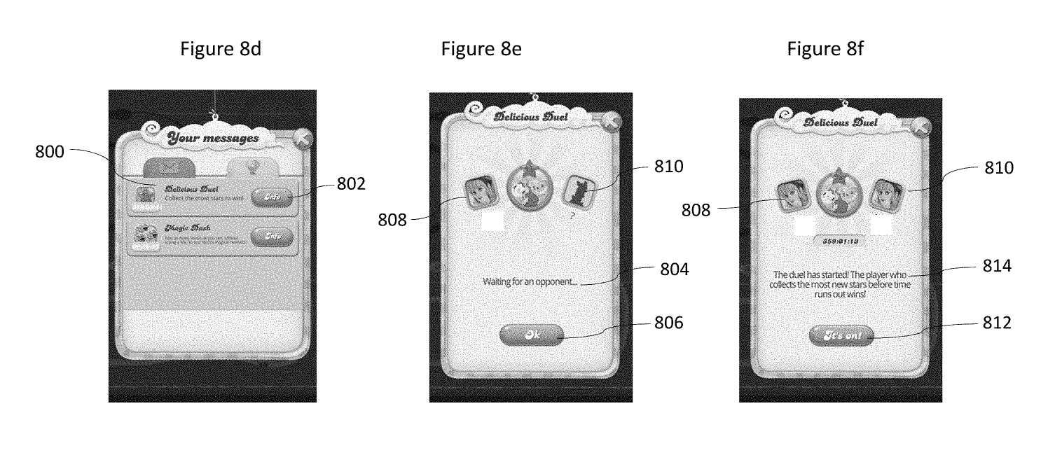

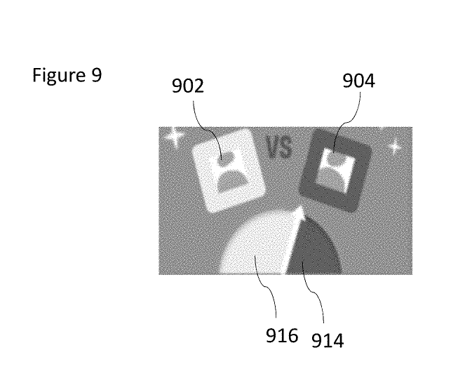

FIG. 9 shows the score area in more detail. The score area 914 has a divider 916 the position of which represents to the user whether the user or the opponent is winning. This is described in more detail with reference to FIG. 10.

Reference is made to FIGS. 10a to 10d which show one example format which can be used to provide score information on a display of a user device. In some embodiments, the score area is represented by a semi-circular part. The semi-circular part will be divided into a first part 950 representing the score of the current player and an area 952 representing the score of the opponent (or vice versa). The boundary 953 between the two areas provides a representation as to how one player is doing with respect to the other.

As can be seen in FIG. 10a, area 950 and 952 are the same size and as such, the number of stars collected by the player and the opponent are the same or generally the same.

In FIG. 10b, the player has increased the number of stars with respect to the opponent and accordingly, the area 950 is larger than the area 952.

In FIGS. 10c and 10d, an increasing numbers of stars achieved is by the current player with respect to the opponent.

At the end of the game, the winner is determined as the player which has the most number of stars and this is represented by the winning player having the largest area.

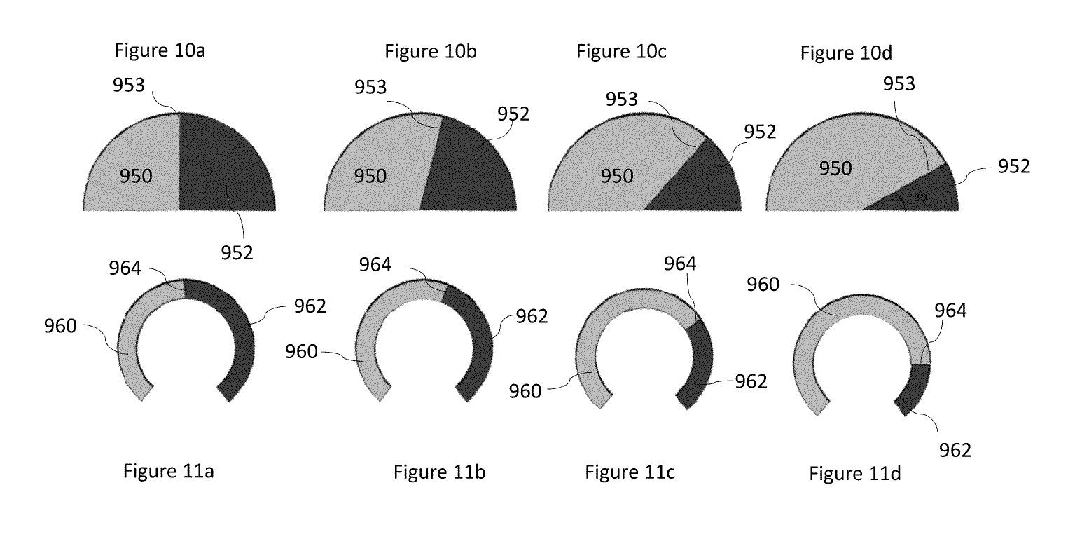

FIGS. 11a to 11 d show a different representation for the same scores in the corresponding FIGS. 10a to 10d. In this example, the scores are represented by an incomplete ring. The part of the ring on the left hand side of the image represents the score of the current player and the area on the right hand side represents the score of the opponent (or vice versa). The position of the boundary 964 represents which player is winning with respect to the other. It should be appreciated that the examples shown in FIGS. 10 and 11 are by way of example only and any other or additional representation may be used for representing the score.

In some embodiments the score information which is presented to the user will show the numerical value of the score of each player. In other embodiments, the information which is presented, such as discussed in relation to FIGS. 10 and/or 11 will not show the numerical value of either of the scores.

In some embodiments, the score information which is presented to the user has a so-called rubber-band effect. For example, this means that the size of the part of the score which is displayed for the losing player will never fall below a certain size, and may for example be the size shown in FIGS. 10d and 11d.

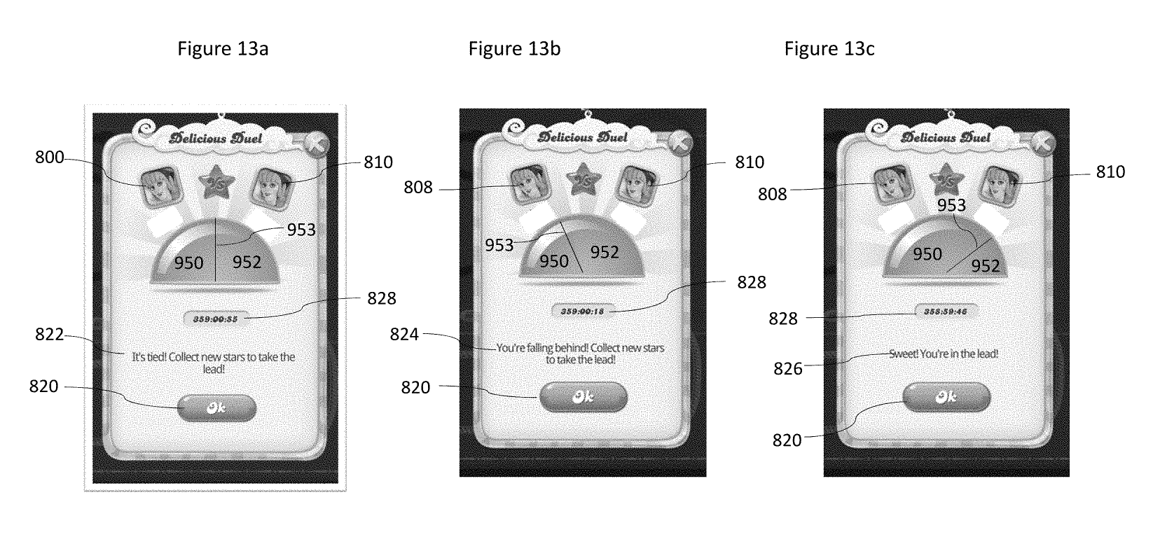

Reference is made to FIGS. 13a to 13c which show example images displayed by the display in one example game. This example game may for example be the example game shown in FIGS. 8d to 8f. This uses the example format of FIGS. 10a to 10d. The first part 950 represents the score of the current player and the area 952 represents the score of the opponent. The boundary 953 between the two areas provides a representation as to how one player is doing with respect to the other. In this example, the image or avatar 808 of the player is displayed adjacent the first part 950 whilst the image or avatar 810 of the opponent is displayed adjacent the second part 952.

FIG. 13a shows an image which is displayed when the scores are the level. A message 822 may be displayed to indicate that the scores are level and/or what is required to take the lead.

FIG. 13b shows an image which is displayed when the current player is behind. A message 824 may be displayed to indicate that the player is behind and/or what is required to take the lead.

FIG. 13c shows an image which is displayed when the current player is in the lead. A message 826 may be displayed to indicate that the player is in the lead.

Each of the images will have time information 828 displayed. The time information may indicate how much time is left in the challenge or how much time of the challenge has lapsed.

Each of the images may have an icon 820 which when selected by the user allow the user to proceed to play the game.

In some embodiments, the one or more of the images may be displayed only if there has been a change in lead or if the scores are levelled. In some embodiments one or more of the images shown in FIGS. 13b and 13c may be displayed a subsequent time if the lead of one of the players has increased by a certain amount since the respective player last saw the respective image.

In some embodiments where a particular player is losing by more than a certain amount as compared to the other player, each collected star for example, may be given a higher value in order to allow the losing player to potential catch up. When then the difference between the players is below the amount, then each collected star would have the same value for both the current player and the opponent. This may be used for example, where the players have different skill level or have different progress levels.

In other embodiments, the rubber banding effect is only to change the visual appearance of the relative score and not the individual scores themselves. It should be appreciated that the rubber banding effect may be controlled by the information provided by the server to the user device. Alternatively the user devices may receive the scores of each player and determine the visualization of the relative scores based on the scores of each player. The rubber banding is useful in that no matter what the differences are in the score between the players, a relative indication can still be displayed without using up a large part of the screen.

An exponential type relationship may be used between the boundary 953 or the like displayed and the difference in, for example, the scores. For example, the greater the differential between the scores of the leader and the loser, the smaller (if any) movement there is of the boundary 953 between the scores as the differential increases. In some embodiments, there may be a maximum position for the boundary which still shows a small area or the like for the losing player.

Thus in embodiments which represent the relative performance on a scale (whether linear, curved or as semi-circular), the scale is non-linear. As the score changes to move a pointer (for example a boundary) along the scale, the differences required to move the pointer away from a neutral point (the point where the scores are level) will increase. As mentioned, in some embodiments, this will be an exponential relationship. Of course, other embodiments may have other types of relationship, either linear or non-linear.

In some embodiments, two or more different criteria may be used. This is so as to allow a match or competition to be competitive even if the skill levels of the two players are different.

In the example shown, the number of stars accumulated by the current player and the number of stars accumulated by the opponent is used to determine which of the current player and the opponent wins a match.

It should be appreciated that collection of stars is by way of example only and in different embodiments, one or more alternative and/or additional parameters may be used to determine which player wins a match.

By way of example only, each level may be associated with a score. In some embodiments, this score may be accumulated in order to determine which of the players has won the match.

Alternatively and/or additionally, one or more of the following may be used to determine which player has won a match: number of objects collected and/or removed; number of unused moves; number of lives sent to another player; number of challenges completed; number of episodes completed (an episode being a set of levels); number of particular game items used, for example particular types of booster; number of game challenges completed; and number of particular items unlocked.

It should be appreciated that in some embodiments only a single criterion is used to determine which player has won. However, in other embodiments, two or more different criteria may be used in order to determine whether a player has won.

In some embodiments, the players may be given two or more different targets, and the performance of the players are compared in order to determine which player has won.

In some embodiments, when an opponent is selected for a player, the player is not given the opportunity to accept or decline the match. However, in other embodiments, a player may have the opportunity to decline to take part in a match.

In some embodiments, when a match or competition is completed, a further time is started. That time may have any suitable value. During that further time, no further matches can be played. At the end of this further time, the player will have a new opponent selected for them. This further time may be controlled by the timer.

It should be appreciated that the length of a match or competition can be any suitable length of time. For example, it may be between 3 to 5 days. Of course, longer or shorter match or competition times may be used in some embodiments. As mentioned, the match or competition times may be dependent on the activity levels of the player and the opponent.

The time between matches, when provided, can have any suitable value and for example may be the order of 24 hours.

In some embodiments, a player may not be provided with opponent and instead is provided with one or more targets to achieve in a given amount of time.

Reference is made to FIGS. 14b and 14c which show example images which are respectively displayed when a user has won the match (FIG. 14b) and lost the match (FIG. 14c). In these example Figures, the avatar or image of the winning player is shown to be larger than the avatar or image of the losing player. In the example of FIG. 14b, the avatar or image 808 of the player is shown to be larger than the avatar or image 810 of the opponent. In the example of FIG. 14c, the avatar or image 808 of the losing player is shown to be smaller than the avatar or image 810 of the opponent. It should be appreciated that alternatively or additionally, any other suitable visual representation may be used to show which of the player and the opponent has won.

In some embodiments, if the player wins the match, the player may be offered a prize, for example an in-game item or reward. This is shown in FIG. 14b. Information about the prize may be provided in a message 856. An icon 858 may be provided which if selected allows the prize to be collected.

In some embodiments, if the player loses the match, the player may be provided with a consolation message 860 as shown in FIG. 14c. An icon 862 may be provided which if selected may take the player back to the game.

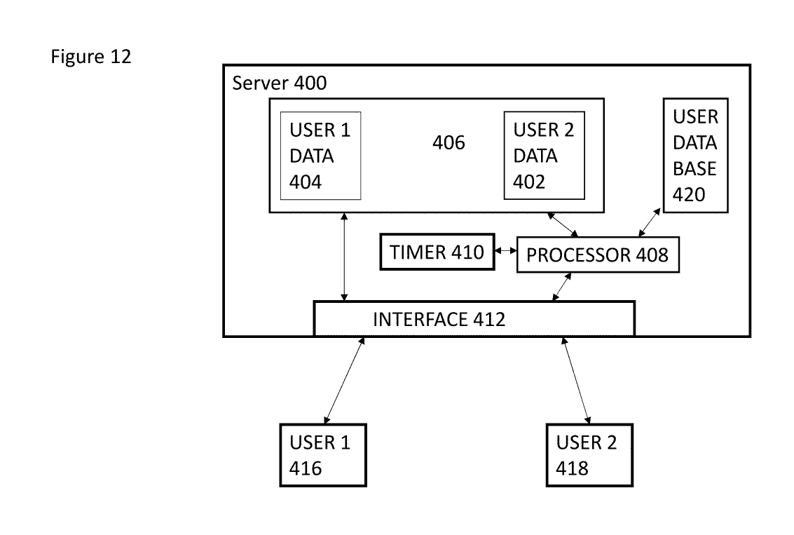

Reference is made to FIG. 12 which shows a server 400 used in some embodiments. The server 400 has an interface 412. This interface allows the server 400 to communicate with a computer device 416 associated with a first user, USER 1 and a computer device 418 associated with a second user, USER 2. It should be appreciated that the computer devices may be for example as described in relation to FIG. 2. It should be appreciated that in the example shown, USER 1 may be the current player and USER 2 may be the opponent.

It should be appreciated that communication between the server and the computer devices will be via a network, such as previously described. The server 400 has a memory 406. This memory 406 may be a database and/or a local memory. The memory 406 has data associated with USER 1 and data associated with USER 2. This is referenced 404 for the USER 1 data and 402 for the data associated with USER 2.

The server 400 has at least one processor 408. The at least one processor 408 is configured to start a timer 410 for a match. The timer 410 is configured to indicate to the processor the one more of the amount of time left in the match or competition and/or the end of a match. The at least one processor 408 will provide the score information to the interface to be provided to the respective user devices. In some embodiments, the current score information may be stored as an appropriate location in the memory.

The at least one processor 408 in this example is configured to control the starting of the match or competition and the determining of the score.

The server may have a database 420 of users from which the opponent is selected. In other embodiments, the database may not be part of the server but the server has access thereto.

In some embodiments, the at least one processor may be configured to perform one or more of the steps of FIG. 4.

In some embodiments, a notification may be transmitted to one or both of the user devices of the players indicating that they have been selected to have a competition.

In some embodiments, a notification of the selection may be provided in-game.

In some embodiments, the game server may send a push message indicating the relative performance metric value to one or both of the players' devices.

The push message may be sent when the relative metric is changed to indicate that a new of the first player and the second player is in the lead. This may be sent to the player no longer in the lead and/or to the player in the lead. In some embodiments, the push message may only be sent when the relative metric would lead to a change in the visualization of the score.

One or other or both of the user devices of the two players may use the received relative performance metric values to visualize the relative performance metric in the respective game. This may for example be as shown in FIG. 10 or 11 or any other visualization.

In some embodiments one or other or both of the user devices of the two players may on receiving an updated relative performance metric value update the visual indication of the relative performance

In some embodiments, the determined game states of the first and second players may be stored.

In some embodiments, the server may for each received performance value determine whether the received performance value outperforms previously received performance values.

In some embodiments, the server may update the game state with an increased performance value when the performance information outperforms previous received performance values.

In some embodiments, the server may determine an increased performance value based on the received performance value and previously received performance values.

In some embodiments, the server may determine a game state associated with the first and second player at the end of the time period of the competition.

In some embodiments, the server may compare the determined game state at the end of the first time period with the stored game state to determine relative performance of the first and second player during the period.

In some embodiments, an in-game reward may be provided to the player outperforming the other player, for example the player which wins the completion. In some embodiments, alternatively or additionally other aspects may be rewarded, For example one or more in-game rewards may be provided depending on number of levels completed, number of stars obtained, time spent playing the game and/or the lie.

The server may be configured to determine if the relative performance needs to be updated each time information about game performance is received from one or other of both of the devices of the first and second players.

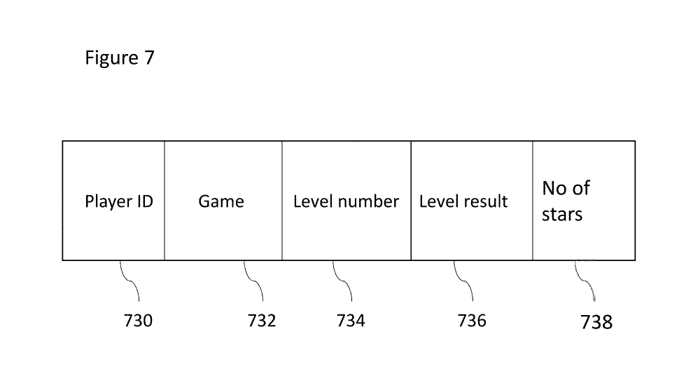

Reference is made to FIG. 7 which shows a data structure used in some embodiments. The user device is configured to use this data structure to send information to the server. It should be appreciated that one or more additional fields may be part of this data structure. One or more of the shown fields may be omitted.

The first field 730 may comprise player identity information or any information which identifies the player to the server. This may for example have a session number where a session number has been allocated to a player or the like.

The second field 732 may have game information identifying the game. This information may be sent in a different message, in some embodiments. In some embodiments, this information is omitted if it is inherent as to which game is being played.

The third field 734 may comprise the level number.

The fourth field 736 may comprise the level result. This may comprise information indicating that the level has been completed. In some embodiments, this may indicate if a level has not been completed.

The fifth field 738 may indicate the number of stars and/or points achieved in the level, if any.

It should be appreciated that in different embodiments, the fields may be different.

The server(s) 400 may also have a games data function. This may use the one or more memories to store the computer game program, user behaviour data and a control part to run the games program and process the user behaviour data. The control part may comprise one or more processors.

Embodiments have been described in the context of two players who play the same game. However, in some embodiments, the two players may be playing different games. For example the games may be both saga games with the same type of scoring structure for completion of a level. In other embodiments, where the games are different, the game performance information of at least one game may need to be modified so that a game metric can be obtained to reflect which player is in the lead and/or has won.

Some embodiments have been described in the context of specific types of product/software. It should be appreciated that this is by way of example only and other embodiments may be implemented using any other product/software.

Embodiments provide computer programs embodied on a distribution medium, comprising program instructions which, when loaded into electronic apparatuses, constitute the apparatuses as explained above. The distribution medium may be a non-transitory medium.

Other embodiments provide computer programs embodied on a computer readable storage medium, configured to control a processor to perform embodiments of the methods described above. The computer readable storage medium may be a non-transitory medium.

The computer program may be in source code form, object code form, or in some intermediate form, and it may be stored in some sort of carrier, distribution medium, or computer readable medium, which may be any entity or device capable of carrying the program. Such carriers include a record medium, computer memory, read-only memory, photoelectrical and/or electrical carrier signal, telecommunications signal, and software distribution package, for example. Depending on the processing power needed, the computer program may be executed in a single electronic digital computer or it may be distributed amongst a number of computers. The computer readable medium or computer readable storage medium may be a non-transitory medium.

An appropriately adapted computer program code product or products may be used for implementing the embodiments, when loaded on an appropriate data processing apparatus, and/or other control operations. The program code product for providing the operation may be stored on, provided and embodied by means of an appropriate carrier medium. An appropriate computer program can be embodied on a computer readable record medium. A possibility is to download the program code product via a data network. In general, the various embodiments may be implemented in hardware or special purpose circuits, software, logic or any combination thereof.

Some embodiments may be provided as a computer program product, included on a computer or machine-readable medium having stored thereon the executable instructions of a computer-readable program that when executed on at least one processor cause a method according to some embodiments to be carried. The terms “computer-readable medium” or “machine-readable medium” as used herein includes any medium that participates in providing instructions to a processor or other components of computer system for execution. Such a medium may take many forms including, but not limited to, storage type media, such as non-volatile media and volatile media, and transmission media. Common forms of non-volatile media include, for example, a floppy disk, a flexible disk, a hard disk, magnetic tape or any other magnetic medium, a compact disc ROM (CD-ROM) or any other optical medium, punch cards or any other physical medium with patterns of holes, a programmable ROM (PROM), an erasable PROM (EPROM), electrically EPROM (EEPROM), a flash memory, any other memory chip or cartridge, or any other medium. Some embodiments may be downloaded or distributed as a computer program product, wherein the computer-readable program instructions may be transmitted from a remote computer such as a server to a user device by way of data signals embodied in a carrier wave or other propagation medium via a network.

The person skilled in the art will realise that the different approaches to implementing the methods and control module are not exhaustive, and what is described herein are certain embodiments. It is possible to implement the above in a number of variations without departing from the spirit or scope of the invention.

1. A computer implemented method comprising:
selecting by at least one processor of a first player of a computer implemented single player game to have a competition with a second player of a computer implemented single player game, said competition lasting a first period of time;
receiving by a receiver game performance information from a first computer device associated with the first player and game performance information from a second computer device associated with the second player, said game performance information being associated with game play of said respective single player computer implemented game within said first period of time;
using by said at least one processor said game performance information associated with the first player, said game performance information associated with the second player and respective game states associated with the first and second players to determine at least one relative game metric for at least a part of said first period of time; and
transmitting by a transmitter said at least one relative game metric to at least one of the first computer device associated with the first player and the second computer device associated with the second player.

2. The method as claimed in claim 1, wherein said computer implemented single player game comprises a casual social game.

3. The method as claimed in claim 1, wherein said computer implemented game comprises a plurality of different levels, said game performance information comprising one of n performance values for a respective level.

4. The method as claimed in claim 3, wherein when said game performance information is for a level which has previously been played, said at least one relative metric is dependent only on one or more additional performance values achieved as compared to a respective performance value previously achieved.

5. The method as claimed in claim 4, comprising using a respective one of said game state and said game performance information to determine said additional game performance values.

6. The method as claimed in claim 1, comprising starting a timer to start said first period of time.

7. The method as claimed in claim 1, wherein said selecting comprises selecting said first player in dependence on activity information associated with said first player and activity information associated with said second player.

8. The method as claimed in claim 1, wherein said selecting comprises selecting said first player from a set of possible first players, said possible first players being identified as social media contacts of said second player.

9. The method as claimed in claim 1, wherein said selecting comprises receiving from said second computer device associated with said second player information identifying said first player.

10. The method as claimed in claim 1, comprising performing a plurality of times during said first time period said steps of using of said game performance information to determine said relative game metric for said first and second players and transmitting said relative game metric to at least one of the first computer device associated with the first player and the second computer device associated with the second player.

11. The method of claim 1, wherein said using and transmitting steps are performed in response to playing of the computer implemented game by at least one of the first and second players on the respective computer device.

12. The method of claim 1, comprising determining that there is at least a defined difference in game performance associated with the first and second players and in response thereto, adjusting the game performance information associated with least one of said first and second players to facilitate a reduction in a difference in said game performance, said relative game metric being dependent on the difference in said game performance.

13. The method of claim 1, comprising transmitting a notification to at least one of said first computer device associated with said first user and said second computer device associated with said second user, said notification comprising information indicating selection of the respective user for said competition.

14. The method of claim 1, wherein said transmitting comprises providing a push message, said push message comprising said information about said at least one relative game metric.

15. The method of claim 15, wherein said push message is provided in response to a change in lead in said competition.

16. The method as claimed in claim 1, using at least one of said first and second computer devices to provide a visualization of said relative performance metric in said respect game.

17. The method as claimed in claim 1, comprising storing said respective game states and updating said game state in response to response to receiving said game performance information.

18. The method as claimed in claim 17, comprising determining if said received game performance indicates an improvement over a previous game performance and updating said game state only if there is an improvement over said previous performance.

19. The method as claimed in claim 1, comprising determining at an end of said first time period a game state associated with said first player and a game state associated with said second player, comparing said determined respective game states at the end of the first time period with the corresponding respective game states at the beginning of the first time period to determine a relative performance of said first and second players.

20. The method as claimed in claim 1, comprising providing an in-game reward to the player having a better performance.

21. A game server comprising:
at least one processor configured to select a first player of a computer implemented single player game to have a competition with a second player of a computer implemented single player game, said competition lasting a first period of time;
at least one memory configured to store respective game states associated with the first and second players;
a receiver configured to receive game performance information from a computer device associated with the first player and game performance information from a computer device associated with the second player, said game performance information being associated with game play of the respective computer implemented single player game within said first period of time, said at least one processor configured to use said game performance information associated with the first player, said game performance information associated with the second player and said respective game states to determine at least one relative game metric for at least a part of said first period of time; and
a transmitter configured to transmit said at least one relative game metric to at least one of the computer device associated with the first player and the computer device associated with the second player.

22. A non-transitory computer readable medium encoded with computer executable instructions for controlling a game server which when executed by at least one processor cause the said at least one processor to perform the following steps:
select a first player of a computer implemented single player game to have a competition with a second player of a computer implemented single player game, said competition lasting a first period of time;
receive game performance information from a computer device associated with the first player and game performance information from a computer device associated with the second player, said game performance information being associated with game play of said respective computer implemented single player game within said first period of time;
use said game performance information associated with the first player and said game performance information associated with the second player and respective game states associated with the first and second players to determine at least one relative game metric for at least a part of said first period of time; and
cause transmission of said at least one relative game metric to at least one of the computer device associated with the first player and the computer device associated with the second player.
